(19) United States
(12) Patent Application Publication
(10) Pub. No.: US 2005/0002135 A1
(43) Pub. Date: Jan. 6, 2005

(54) Pump drive motor control apparatus

(76) Inventor: Koichi Kokubo, Kariya-shi (JP)

Correspondence Address: BURNS DOANE SWECKER & MATHIS L L P, POST OFFICE BOX 1404, ALEXANDRIA, VA, 22313-1404, US

(21) Appl. No.: 10/847,283

(22) Filed: May 18, 2004

(30) Foreign Application Priority Data
May 30, 2003 (JP) 2003-154761

(51) Int. Cl. H02H 7/08

(52) U.S. Cl. 361/23

(57) ABSTRACT

A pump drive motor control apparatus is applied to a motor for driving a hydraulic pump which pumps brake fluid returned to a reservoir as a result of ABS control and supplies the pumped brake fluid to a hydraulic circuit. When a motor inter-terminal voltage becomes equal to or less than a voltage threshold in a period during which a motor control signal is at a low level (supply of electricity to the motor is stopped), the control apparatus changes the motor control signal to a high level (resumes the supply of electricity) for a predetermined time, to thereby control the rotational speed of the motor. The control apparatus reduces the rotational speed of the motor by lowering the voltage threshold, which affects the rotational speed of the motor, with the vehicle body deceleration during ABS control, which corresponds to the friction coefficient of road surface, which determines the required discharge flow rate of the hydraulic pump.

### BACKGROUND OF THE INVENTION

1. Field of the Invention

The present invention relates to a pump drive motor control apparatus for controlling the rotational speed of a motor for driving a pump, and more particularly to a pump drive motor control apparatus which controls the rotational speed of a motor through on-off control performed such that supply of electricity to the motor is resumed on the basis of a result of comparison between a predetermined threshold and a voltage which the motor generates during a period in which supply of electricity to the motor is stopped.

2. Description of the Related Art

A conventional pump drive motor control apparatus of such a type is disclosed in, for example, Japanese kohyo (PCT) Patent Publication No. 2002-506406. The disclosed control apparatus is applied to a motor for driving a hydraulic pump which is used in an antilock brake system in order to pump brake fluid returned to a reservoir as a result of operation of the antilock brake system and to supply the pumped brake fluid to a hydraulic circuit of the antilock brake system. The control apparatus controls the rotational speed of the motor through on-off control performed such that supply of electricity to the motor is resumed when a voltage which the motor generates during a period in which supply of electricity to the motor is stopped (i.e., an induced electromotive force which the motor generates as a result of acting as a generator) becomes equal to or less than a predetermined threshold.

A hydraulic pump and a motor as described above are required to reduce their operation sound (or noise) to the extent possible. The lower the time-average rotational speed of the motor (hereinafter, may be simply referred to as “rotational speed of the motor”), the smaller the operation sound. Accordingly, the rotational speed of the motor is desirably lowered to the extent possible.

Meanwhile, the operation conditions of an antilock brake system varies in accordance with the conditions of a road surface on which a vehicle travels, and therefore, the time average of quantity of brake fluid returned to a reservoir per unit time as a result of operation of the system (hereinafter, may be simply referred to as “flow rate of the brake fluid”) also varies in accordance with the conditions of the road surface on which the vehicle travels. In general, the flow rate of the brake fluid returned to the reservoir tends to increase with increasing friction coefficient of the road surface on which the vehicle travels.

Moreover, if the reservoir is filled with brake fluid, further return of brake fluid from the hydraulic circuit of the antilock brake system to the reservoir becomes impossible, resulting in failure of the antilock brake system to attain brake fluid pressure control (hereinafter, referred to as “ABS control”). Accordingly, brake fluid must be pumped out of the reservoir in order to prevent the brake fluid from filling the reservoir. Notably, a time-average flow rate at which the hydraulic pump pumps brake fluid out of the reservoir and discharges (hereinafter, may be simply referred to as “discharge flow rate”) increases with the rotational speed of a motor for driving the hydraulic pump. In view of the foregoing, in order to avoid failure of the ABS control, while reducing the operation sound to the extent possible, the rotational speed of the motor is preferably changed in accordance with the flow rate at which brake fluid is returned to the reservoir (accordingly, in accordance with the road surface conditions).

Meanwhile, the rotational speed of the motor depends on the above-described threshold, and increases with the threshold. However, in the disclosed apparatus, since the above-described threshold is fixed, the rotational speed of the motor cannot be changed in accordance with the road surface condition, with the result that the above-described reduction of operation sound and the above-described avoidance of failure of the ABS control cannot be achieved at the same time. In other words, the conventional control apparatus has a drawback in that reduction of operation sound of the motor (and the pump) and securing of a required discharge flow rate of the pump cannot be achieved at the same time.

### SUMMARY OF THE INVENTION

An object of the present invention is to provide a pump drive motor control apparatus for controlling the rotational speed of a motor for driving a pump, which apparatus can simultaneously attain reduction of operation sound of the motor and securing of a required discharge flow rate of the pump.

In order to achieve the above object, the present invention provides a pump drive motor control apparatus for controlling a motor for driving a pump, comprising: control means for controlling rotational speed of the motor through on-off control performed such that supply of electricity to the motor is resumed on the basis of a result of comparison between a predetermined threshold and a voltage which the motor generates in a state in which supply of electricity to the motor is stopped; and threshold changing means for changing the threshold in accordance with a quantity of working fluid which the pump is required to discharge.

The control means is preferably configured to resume supply of electricity to the motor when the voltage which the motor generates in a state in which supply of electricity to the motor is stopped (i.e., an induced electromotive force generated as a result of the motor serving as a generator) becomes equal to or less than the threshold.

By virtue of the above configuration, the threshold can be increased with the quantity of working fluid which the pump is required to discharge (e.g., a required discharge flow rate of the pump). As a result, the motor (and the pump) can be controlled such that its rotational speed increases with the required discharge flow rate of the pump. Accordingly, reduction of the operation sound of the motor and securing of the required discharge flow rate can be attained simultaneously.

In this case, preferably, the pump driven by the motor is a hydraulic pump used in a brake fluid pressure controller of a vehicle including at least an antilock brake system, the hydraulic pump pumping brake fluid returned to a reservoir as a result of operation of the brake fluid pressure controller and supplying the pumped brake fluid to a hydraulic circuit of the brake fluid pressure controller; the control means controls the rotational speed of the motor at least during a period in which the brake fluid pressure controller is operating; and the threshold changing means changes the threshold on the basis of a value varying in accordance with conditions of a road surface on which the vehicle travels, during the period in which the brake fluid pressure controller is operating.

Examples of the “value varying in accordance with road surface conditions” include, but are not limited to, deceleration of the vehicle body during ABS control, friction coefficient of road surface, and a value representing the degree of roughness of road surface. As described above, the flow rate of brake fluid returned to the reservoir as a result of ABS control varies depending on the conditions of a road surface on which the vehicle travels. In such a case, the required discharge flow rate of the pump can be determined on the basis of the conditions of the road surface.

By virtue of the above configuration, since the threshold can be changed in accordance with the “value varying in accordance with road surface conditions,” the rotational speed of the motor can be changed in accordance with the conditions of a road surface on which the vehicle travels. Accordingly, as described above, it becomes possible to simultaneously achieve reduction of the operation sound of the motor and avoidance of failure of the ABS control.

Preferably, the threshold changing means is configured to change the threshold on the basis of deceleration of the vehicle body during a period in which the brake fluid pressure controller is operating, the deceleration serving as the value varying in accordance with road surface conditions. The deceleration of the vehicle body can be obtained (estimated) on the bases of a wheel speed sensor for detecting wheel speed of each wheel of the vehicle. In the antilock brake system, since the wheel speed of each wheel of the vehicle must be obtained in order to perform ABS control, the wheel speed sensor is an essential component. Accordingly, the above-described configuration simultaneously achieves reduction of the operation sound of the motor and avoidance of failure of the ABS control, by use of an inexpensive configuration, without addition of dedicated sensors or the like for changing the threshold.

More preferably, the threshold changing means is configured to change the threshold on the basis of a value representing the degree of roughness of road surface during a period in which the brake fluid pressure controller is operating, the value representing the degree of roughness serving as the value varying in accordance with road surface conditions. The value representing the degree of roughness of road surface can be obtained on the basis of, for example, a value representing the degree of variation among the wheel speeds of the wheels (e.g., the difference between the maximum wheel speed and the minimum wheel speed).

In general, during travel on a poor road, the flow rate of brake fluid returned to the reservoir tends to increase. Therefore, the rotational speed of the motor is desirably increased with higher priority imparted to avoidance of failure of ABS control. When the threshold changing means is configured to change the threshold on the basis of the value representing the degree of road surface roughness, the threshold can be increased with the degree of road surface roughness. As a result, the rotational speed of the motor (and the pump) can be increased when the degree of road surface roughness exceeds a predetermined level. Accordingly, failure of ABS control, which would otherwise occur during travel on a poor road, can be avoided without fail.

### BRIEF DESCRIPTION OF THE DRAWINGS

Various other objects, features and many of the attendant advantages of the present invention will be readily appreciated as the same becomes better understood by reference to the following detailed description of the preferred embodiment when considered in connection with the accompanying drawings, in which:

FIG. 1 is a schematic diagram of a vehicle equipped with a vehicle control apparatus including a pump drive motor control apparatus according to an embodiment of the present invention;

FIG. 2 is a schematic diagram of a brake fluid pressure controller shown in FIG. 1;

FIG. 3 is a schematic diagram of a drive circuit for driving and controlling a motor MT shown in FIG. 2;

FIG. 4 is a graph showing a map which defines the relationship between vehicle body deceleration and voltage threshold and to which a CPU shown in FIG. 1 refers;

FIG. 5 is a time chart showing example changes in the motor inter-terminal voltage and motor control signal shown in FIG. 3 during execution of ABS control (during drive-control of the motor MT);

FIG. 6 is a flowchart showing a routine which the CPU shown in FIG. 1 executes in order to calculate wheel speed, etc.;

FIG. 7 is a flowchart showing a routine which the CPU shown in FIG. 1 executes in order to make judgment on start and end of ABS control;

FIG. 8 is a flowchart showing a routine which the CPU shown in FIG. 1 executes in order to set a voltage threshold; and

FIG. 9 is a flowchart showing a routine which the CPU shown in FIG. 1 executes in order to generate a motor control signal.

### DESCRIPTION OF THE PREFERRED EMBODIMENT

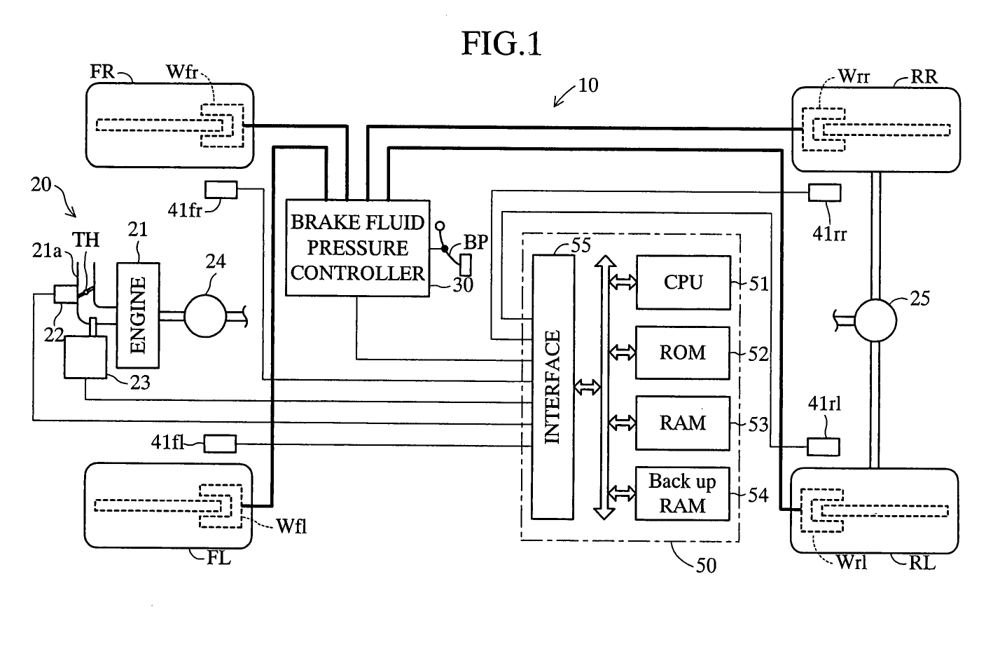

An embodiment of a pump drive motor control apparatus according to the present invention will be described with reference to the drawings. FIG. 1 schematically shows the structure of a vehicle equipped with a vehicle control apparatus 10 including a pump drive motor control apparatus according to the embodiment of the present invention. The illustrated vehicle is a four-wheel, rear-wheel drive (FR) vehicle having two front wheels (a front left wheel FL and a front right wheel FR) which are non-drive wheels (follower wheels), and two rear wheels (a rear left wheel RL and a rear right wheel RR) which are drive wheels.

This vehicle control apparatus 10 has a drive force transmission mechanism 20 which generates a drive force and transmits it to the drive wheels RL and RR; and a brake fluid pressure controller 30 for generating a braking force in each wheel by means of brake fluid pressure.

The drive force transmission mechanism 20 comprises an engine 21 which generates a drive force, a throttle valve actuator 22 comprising a DC motor which controls the opening of a throttle valve TH which is disposed in an intake pipe 21 a of the engine 21 and which varies the open cross-sectional area of the intake passage; a fuel injection apparatus 23 which includes fuel injectors which inject fuel in the vicinity of unillustrated intake ports of the engine 21; a transmission 24 having an input shaft connected to an output shaft of the engine 21, and a differential gear 25 which distributes between the rear wheels RR and RL the drive force which is transmitted from an output shaft of the transmission 24.

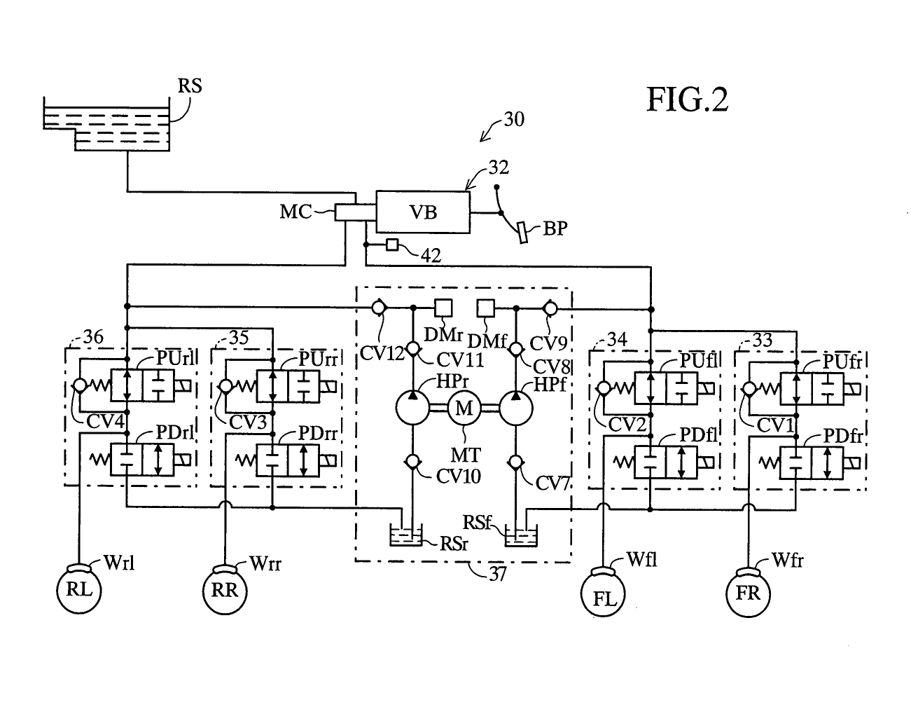

As schematically shown in FIG. 2, the brake fluid pressure controller 30 includes a brake fluid pressure generating section 32 which generates brake fluid pressure corresponding to the operating force of a brake pedal BP; an FR brake fluid pressure adjusting section 33, an FL brake fluid pressure adjusting section 34, an RR brake fluid pressure adjusting section 35, and an RL brake fluid pressure adjusting section 36, which can adjust the brake fluid pressures supplied to corresponding wheel cylinders Wfr, Wfl, Wrr, and Wrl respectively installed on the wheels FR, FL, RR, and RL; and a return brake fluid supply section 37.

The brake fluid pressure generating section 32 includes a vacuum booster VB which operates in response to operation of the brake pedal BP, and a master cylinder MC which is linked to the vacuum booster VB. The vacuum booster VB utilizes the pressure (negative pressure) of air within the intake pipe 21 a of the engine 21 so as to boost the operating force of the brake pedal BP by a prescribed ratio and transmits the boosted operating force to the master cylinder MC.

The master cylinder MC has two output ports; i.e., a first port and a second port. The master cylinder MC receives brake fluid from a reservoir RS, and generates from the first port a first master cylinder fluid pressure corresponding to the boosted operating force. The master cylinder MC also generates from the second port a second master cylinder fluid pressure which is substantially the same as the first master cylinder fluid pressure and which corresponds to the boosted operating force. The structures and operations of the master cylinder MC and the vacuum booster VB are well known, and therefore an explanation of the details thereof will be omitted. In this manner, the master cylinder MC and the vacuum booster VB generate first and second master cylinder fluid pressures corresponding to the operating force of the brake pedal BP.

The first port of the master cylinder MC is connected to the upstream side of the FR brake fluid pressure adjusting section 33 and the upstream side of the FL brake fluid pressure adjusting section 34. Similarly, the second port of the master cylinder MC is connected to the upstream side of the RR brake fluid pressure adjusting section 35 and the upstream side of the RL brake fluid pressure adjusting section 36. Thus, the first master cylinder fluid pressure is supplied to the upstream side of the FR brake fluid pressure adjusting section 33 and the upstream side of the FL brake fluid pressure adjusting section 34, and the second master cylinder fluid pressure is supplied to the upstream side of the RR brake fluid pressure adjusting section 35 and the upstream side of the RL brake fluid pressure adjusting section 36.

The FR brake fluid pressure adjusting section 33 consists of a pressure increasing valve PUfr, which is a normally-open solenoid valve of a 2-port, 2-position type, and a pressure reducing valve PDfr, which is a normally-closed solenoid valve of a 2-port, 2-position type. When the pressure increasing valve PUfr is in its first position (a position in a nonexcited state) shown in FIG. 2, it establishes communication between the upstream side of the FR brake fluid pressure adjusting section 33 and the wheel cylinder Wfr. When the pressure increasing valve PUfr is in its second position (a position in an excited state), it breaks the communication between the upstream side of the FR brake fluid pressure adjusting section 33 and the wheel cylinder Wfr. When the pressure reducing valve PDfr is in its first position (a position in a nonexcited state) shown in FIG. 2, it breaks communication between the wheel cylinder Wfr and a reservoir RSf. When the pressure reducing valve PDfr is in its second position (a position in an excited state), it establishes the communication between the wheel cylinder Wfr and the reservoir RSf.

With this structure, when the pressure increasing valve PUfr and the pressure reducing valve PDfr are in their first positions, the fluid pressure in the wheel cylinder Wfr is increased upon supply of pressurized brake fluid from the upstream side of the FR brake fluid pressure adjusting section 33 into the wheel cylinder Wfr. When the pressure increasing valve PUfr is in the second position and the pressure reducing valve PDfr is in the first position, regardless of the fluid pressure in the upstream side of the FR brake fluid pressure adjuster 33, the fluid pressure in the wheel cylinder Wfr at the time of changeover is maintained. When the pressure increasing valve PUfr and the pressure reducing valve PDfr are in their second positions, the brake fluid within the wheel cylinder Wfr is allowed to return to the reservoir RSf, whereby the fluid pressure in the wheel cylinder Wfr is decreased.

A check valve CV1 which allows flow of the brake fluid in only one direction from the wheel cylinder side Wfr to the upstream side of the FR brake fluid pressure adjuster 33 is connected in parallel with pressure increasing valve PUfr. As a result, when the brake pedal BP is released after being operated, the brake fluid pressure in the wheel cylinder Wfr is rapidly decreased.

Similarly, the FL brake fluid pressure adjuster 34, the RR brake fluid pressure adjuster 35, and the RL brake fluid pressure adjuster 36 comprise a pressure increasing valve PUfl and a pressure reducing valve PDfl, a pressure increasing valve PUrr and a pressure reducing valve PDrr, and a pressure increasing valve PUrl and a pressure reducing valve PDrl, respectively. By controlling the positions of each pressure increasing valve and pressure reducing valve, the brake fluid pressure in the wheel cylinder Wfl, the wheel cylinder Wrr, and the wheel cylinder Wrl can be increased, maintained, or decreased. Checks valves CV2, CV3, and CV4 are provided in parallel with the pressure increasing valves PUfl, PUrr, and PUrl, respectively, to provide the same function as that of the check valve CV1.

The return brake fluid supply section 37 includes a DC motor MT, and two hydraulic pumps HPf and HPr simultaneously driven by the motor MT. The hydraulic pump HPf pumps via a check valve CV7 the brake fluid returned from the pressure reducing values PDfr and PDfl to the reservoir RSf, and supplies the pumped brake fluid to the upstream sides of the FR brake fluid pressure adjuster 33 and the FL brake fluid pressure adjuster 34 via check valves CV8 and CV9.

Similarly, the hydraulic pump HPr pumps via a check valve CV10 the brake fluid returned from the pressure reducing values PDrr and PDrl to the reservoir RSr, and supplies the pumped brake fluid to the upstream sides of the RR brake fluid pressure adjuster 35 and the RL brake fluid pressure adjuster 36 via check valves CV11 and CV12. Notably, in order to reduce pulsations of discharge pressures of the hydraulic pumps HPf and HPr, dampers DMf and DMr are disposed in a hydraulic circuit between the check valves CV8 and CV9 and a hydraulic circuit between the check valves CV11 and CV12, respectively.

With the structure described above, when all the solenoid valves are in their first positions, the brake fluid pressure controller 30 supplies to each wheel cylinder a brake fluid pressure corresponding to the operating force of the brake pedal BP. In this state, it become possible to decrease only the brake fluid pressure in, for example, the wheel cylinder Wrr by a prescribed amount through control of the pressure increasing valve PUrr and the pressure reducing valve PDrr. That is, the brake fluid pressure controller 30 can individually decrease the brake fluid pressure in the wheel cylinder of each wheel from the brake fluid pressure corresponding to the operating force of the brake pedal BP.

Meanwhile, the vehicle control apparatus 10 includes wheel speed sensors 41fl, 41fr, 41rl, and 41rr (see FIG. 1) which each output a signal having a pulse each time the corresponding wheel rotates by a prescribed angle; and a pressure sensor 42 (see FIG. 2) for detecting the first master cylinder fluid pressure generated by the master cylinder MC and for outputting a signal indicative of the first master cylinder fluid pressure.

Moreover, the vehicle control apparatus 10 includes an electronic controller 50. The electronic controller 50 is a microcomputer which includes a CPU 51; ROM 52 in which are previously stored routines (programs) to be executed by the CPU 51, tables (look-up tables and maps), constants, and the like; RAM 53 in which the CPU 51 temporarily stores data as necessary; backup RAM 54 which store data when the power supply is on and which maintains the stored data when the power supply is cut off; an interface 55 containing A/D converters; and the like. The above components are interconnected via a bus.

The interface 55 is connected to the above sensors 41 and 42 and supplies signals from the sensors 41 and 42 to the CPU 51, and it outputs drive signals to each of the solenoid valves and the motor MT of the brake fluid pressure controller 30, the throttle valve actuator 22, the fuel injection apparatus 23, and a power transistor Tr, which will be described later, in accordance with instructions from the CPU 51.

The throttle valve actuator 22 (CPU 51) drives the throttle valve TH so that the opening of the throttle valve TH becomes an opening corresponding to the operating position of an unillustrated accelerator pedal, and the fuel injection apparatus 23 (CPU 51) injects a necessary amount of fuel so as to obtain a target air-fuel ratio (a theoretical air-fuel ratio) with respect to the air intake amount corresponding to the opening of the throttle valve TH.

The brake fluid pressure controller 30 (CPU 51) executes the above-described ABS control, which is the control of properly decreasing the brake fluid pressure for a specific wheel from the brake fluid pressure corresponding to the operating force of the brake pedal BP, when the specific wheel tends to lock while the driver is operating the brake pedal BP. Since the details of the ABS control are well known, a repeated description therefor will be omitted.

Outline of Rotational Speed Control for Motor MT

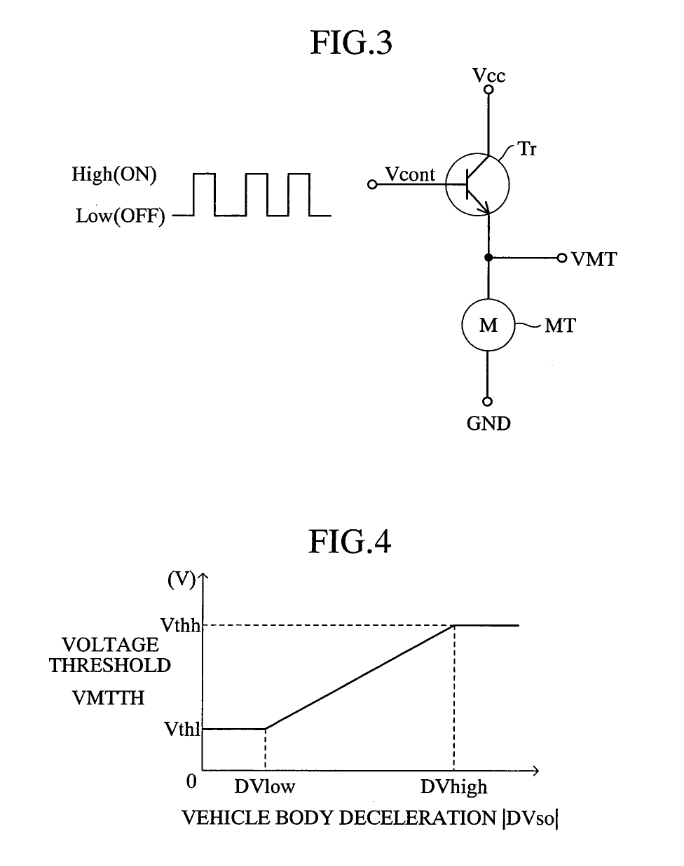

The pump drive motor control apparatus according to the present invention (hereinafter, may be referred to as the “present apparatus”) incorporated in the above-described vehicle control apparatus 10 is applied to the above-described motor MT, and is designed to control the rotational speed of the motor MT by use of the power transistor (switching element) Tr shown in FIG. 3 and incorporated in the electronic controller 50, while the predetermined pump (the hydraulic pumps HPf, HPr) drive-control condition is satisfied.

More specifically, as shown in FIG. 3, the collector terminal of the power transistor Tr is connected to the power source (voltage: Vcc (12 V in the present example)) of the vehicle, and the emitter terminal of the power transistor Tr is connected to one terminal of the motor MT. The other terminal of the motor MT is grounded (voltage: GND level). A motor control signal Vcont, which is generated in accordance with an instruction from the present apparatus (CPU 51), is applied to the base terminal of the power transistor Tr.

As shown in FIG. 3, the motor control signal Vcont is generated to assume a High level or a Low level. The power transistor Tr is in an on state when the motor control signal Vcont is at the High level, and is in an off state when the motor control signal Vcont is at the Low level. In other words, when the motor control signal Vcont is at the High level, the voltage Vcc is applied to the motor MT, whereby the motor MT drives the hydraulic pumps HPf and HPr (the supply of electricity to the motor MT is effected), and when the motor control signal Vcont is at the Low level, the voltage Vcc is not applied to the motor MT (the supply of electricity to the motor MT is stopped).

As a result, when the motor control signal Vcont is at the High level, a motor inter-terminal voltage VMT (see FIG. 3), which is a voltage between the two terminals of the motor MT, becomes constant (voltage Vcc). Meanwhile, when the motor control signal Vcont is at the Low level, a voltage generated by the motor MT is output as the motor inter-terminal voltage VMT. The voltage generated by the motor MT is an induced voltage or electromotive force which the motor MT generates as a result of acting as a generator. The generated voltage decreases with the rotational speed of the motor MT, which continues rotation because of inertia, and becomes zero when the rotational speed becomes zero.

The present apparatus performs the following control. When the motor inter-terminal voltage VMT (accordingly, the generated voltage) becomes equal to or less than a voltage threshold VMTTH, which serves as a predetermined threshold, in a state in which the motor control signal Vcont is at the Low level (accordingly, the supply of electricity to the motor MT is stopped), the present apparatus switches the motor control signal Vcont from the Low level to the High level (accordingly, resumes the supply of electricity to the motor MT), and maintains the motor control signal Vcont at the High level for a predetermined period of time Thigh after the switching (accordingly, continues the supply of electricity to the motor MT for a predetermined period of time Thigh after the switching) so as to drive the hydraulic pumps HPf and HPr. Subsequently, the present apparatus switches the motor control signal Vcont from the High level to the Low level (accordingly, stops the supply of electricity to the motor MT) so as to stop the drive of the hydraulic pumps HPf and HPr. In this state (the motor control signal Vcont is at the Low level), the motor inter-terminal voltage VMT (accordingly, the generated voltage) decreases with the rotational speed of the motor MT, which continues rotation because of inertia. When the motor inter-terminal voltage VMT becomes equal to or less than the voltage threshold VMTTH, the present apparatus again switches the motor control signal Vcont from the Low level to the High level. So long as the predetermined pump drive-control condition is satisfied, the present apparatus repeats the above-described operation so as to start and stop the supply of electricity to the motor MT, to thereby control the rotational speed of the motor MT. As is understood from the above, the means for controlling the rotational speed of the motor MT corresponds to the control means.

Incidentally, the above-described hydraulic pumps HPf and HPr and motor MT are required to reduce their operation sounds to the extent possible. The lower the rotational speed of the motor MT, the smaller the operation sound. Accordingly, the rotational speed of the motor MT is desirably lowered to the extent possible.

However, since the operation conditions (open/close timings, etc.) of the respective solenoid valves (in particular, the pressure reducing valves PDfr, etc.) in ABS control vary in accordance with the conditions of a road surface on which the vehicle travels, the flow rate (quantity per unit time) of brake fluid returned to the reservoirs RSf and RSr also varies in accordance with the conditions of the road surface. In general, the flow rate of the brake fluid returned to the reservoirs RSf and RSr tends to increase with the friction coefficient of the road surface on which the vehicle travels.

Moreover, if the reservoirs RSf and RSr are filled with brake fluid, further return of brake fluid from the pressure reducing valves PDfr, etc. to the reservoirs RSf and RSr becomes impossible, resulting in failure of the ABS control. Accordingly, the hydraulic pumps HPf and HPr must pump brake fluid from the reservoirs RSf and RSr in order to prevent the brake fluid from filling the reservoirs RSf and RSr. Meanwhile, the flow rate at which the hydraulic pumps HPf and HPr pump brake fluid from the reservoirs RSf and RSr; i.e., the discharge flow rates of the hydraulic pumps HPf and HPr, increase with the rotational speed of the motor MT.

In view of the foregoing, in order to avoid a failure of the ABS control, while reducing the above-described operation sounds to the extent possible, the rotational speed of the motor MT is preferably decreased with decreasing flow rate of brake fluid returned to the reservoirs RSf and RSr. In other words, the rotational speed of the motor MT is preferably decreased with the friction coefficient of a road surface on which the vehicle travels.

Meanwhile, the deceleration (positive value) of the vehicle body during ABS control depends on the friction coefficient of a road surface on which the vehicle travels, and decreases with the friction coefficient of the road surface. Accordingly, the deceleration of the vehicle body during ABS control can serve as a value which represents the friction coefficient of a road surface on which the vehicle travels (accordingly, a value which varies in accordance with road surface conditions). Further, the rotational speed of the motor MT depends on the above-described voltage threshold VMTTH, and decreases with the voltage threshold VMTTH.

In view of the foregoing, so long as the predetermined pump drive-control condition is satisfied, the present apparatus changes (updates) the voltage threshold VMTTH on the basis of an estimated vehicle body deceleration |DVso|, which is the absolute value of a differentiated value of an estimated vehicle body speed calculated as described below, and with reference to a map shown in FIG. 4 which defines the relation between the estimated vehicle body deceleration |DVso| and the voltage threshold VMTTH. By virtue of this operation, the voltage threshold VMTTH is maintained at a constant level Vthh (V) when the estimated vehicle body deceleration |DVso| is equal to or higher than DVhigh, is decreased linearly from Vthh (V) to Vthl (V) with the estimated vehicle body deceleration |DVso| when the estimated vehicle body deceleration |DVso| falls between DVlow and DVhigh, and is maintained at a constant level Vthl (V) when the estimated vehicle body deceleration |DVso| is equal to or lower than DVlow. As is understood from the above, the means for updating the voltage threshold VMTTH corresponds to the threshold changing means.

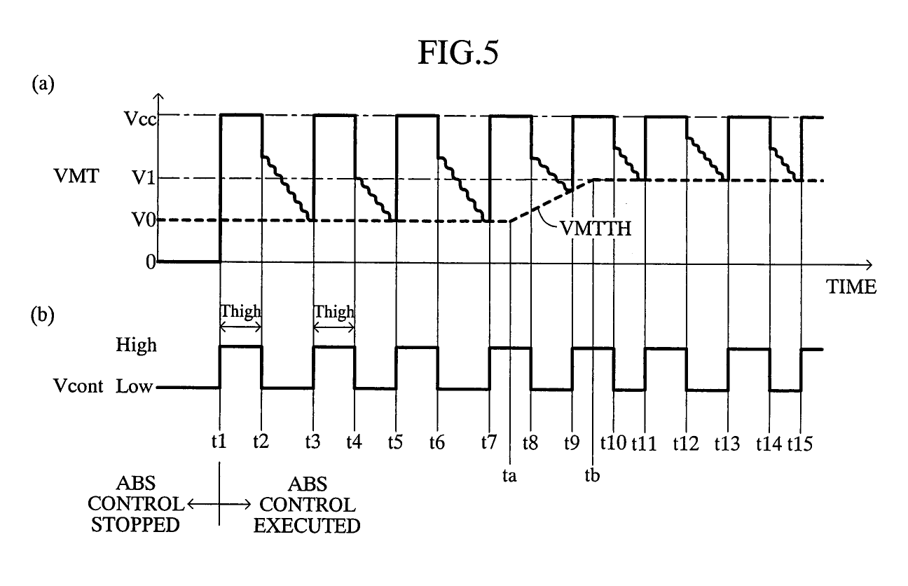

FIG. 5 is a time chart showing example changes in the motor inter-terminal voltage VMT and the motor control signal Vcont for the case in which a certain wheel is locked because the driver strongly operates the brake pedal BP while the vehicle travels on a road surface having a relatively small friction coefficient, whereby the predetermined pump drive-control condition is satisfied at and after time t1. In this time chart, during a period between time t1 to time ta, the road surface on which the vehicle travels has a relatively small friction coefficient (accordingly, the estimated vehicle body deceleration |DVso| is small), and therefore, the voltage threshold VMTTH is maintained at a value V0. Meanwhile, during a period between time ta to time tb, the friction coefficient of the road surface gradually increases (accordingly, the estimated vehicle body deceleration |DVso| gradually increases), and therefore, the voltage threshold VMTTH is gradually increased from the value V0 to a value V1, and after time tb, the voltage threshold VMTTH is maintained at the value V1.

As shown in FIG. 5, before time t1, the motor control signal Vcont is maintained at the Low level (see (b)), and the hydraulic pumps HPf and HPr are stopped, so that the motor inter-terminal voltage VMT is 0 V (see (a)). When time t1 is reached in this state, because the motor inter-terminal voltage VMT (=0 V) is lower than the voltage threshold VMTTH (=V0), the present apparatus switches the motor control signal Vcont from the Low level to the High level at time t1, and maintains the motor control signal Vcont at the High level until the predetermined period of time Thigh elapses after time t1 (i.e., from t1 to t2). As a result, during the period of t1 to t2, the motor inter-terminal voltage VMT is maintained at a constant level (Vcc), and the motor MT (accordingly, the hydraulic pumps HPf and HPr) is driven.

At time t2, the present apparatus switches the motor control signal Vcont from the High level to the Low level so as to stop the drive of the motor TM (accordingly, the hydraulic pumps HPf and HPr). As a result, after time t2, due to influence of the braking force which is imposed on the motor MT by means of brake fluid remaining on the discharge sides of the hydraulic pumps HPf and HPr, and the like, the rotational speed of the motor MT gradually decreases, and the motor inter-terminal voltage VMT (accordingly, the above-described generated voltage) gradually decreases.

Subsequently, during a period before time ta in which the voltage threshold VMTTH is maintained at the value V0, whenever the motor inter-terminal voltage VMT decreases to the value V0 (see times t3, t5, and t7), the present apparatus switches the motor control signal Vcont from the Low level to the High level, and, upon passage of the predetermined period of time Thigh (see times t4, t6, and t8), switches the motor control signal Vcont from the High level to the Low level.

Meanwhile, the voltage threshold VMTTH increases during a period from ta before t8 to tb after t8. Accordingly, at time t9 at which the motor inter-terminal voltage VMT is first decreased to the voltage threshold VMTTH after time t8 (before time tb), the present apparatus switches the motor control signal Vcont from the Low level to the High level when the motor inter-terminal voltage VMT assumes a certain value between the values V0 and V1. Subsequently, upon passage of the predetermined period of time Thigh (see time t10), the present apparatus switches the motor control signal Vcont from the High level to the Low level.

In a period after time tb, during which the voltage threshold VMTTH is maintained at the value V1, whenever the motor inter-terminal voltage VMT decreases to the value V1 (see times t11, t13, and t15), the present apparatus switches the motor control signal Vcont from the Low level to the High level, and, upon passage of the predetermined period of time Thigh (see times t12 and t14), switches the motor control signal Vcont from the High level to the Low level.

As described above, so long as the predetermined pump drive-control condition is satisfied, the present apparatus controls the rotational speed of the motor MT by decreasing the voltage threshold VMTTH as the estimated vehicle body deceleration |DVso| decreases. Accordingly, the rotational speed (the time average thereof) of the motor MT decreases with the estimated vehicle body deceleration |DVso|. The above is the outline of the rotational speed control for the motor MT.

Actual Operation

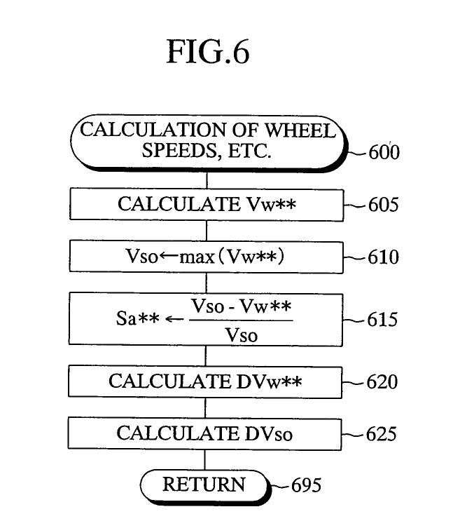

The actual operation of the vehicle control apparatus 10 including the pump drive motor control apparatus according to the present invention having the above-described structure will be explained while referring to FIGS. 6 to 9, which show, in the form of flowcharts, routines which are executed by the CPU 51 of the electronic controller 50. Notably, the symbol ** attached to the ends of various variables and the like collectively represents the symbols fl, fr, rl, and rr and indicates that the particular variable or the like applies to all of the wheels FR, FL, etc. of the vehicle. For example, the wheel speed Vw** collectively indicates the front left wheel speed Vwfl, the front right wheel speed Vwfr, the rear left wheel speed Vwrl, and the rear right wheel speed Vwrr.

At predetermined time intervals, the CPU 51 repeatedly performs a routine shown in FIG. 6 for calculating the wheel speed Vw* and other parameters. Accordingly, when a predetermined timing is reached, the CPU 51 starts processing of the routine from Step 600, and proceeds to Step 605 so as to calculate the wheel speed Vw** of the wheel (the speed of the outer periphery of the wheel**). Specifically, the CPU 51 calculates the wheel speed Vw** on the basis of the time intervals between pulses of a signal which each wheel speed sensor 41** outputs.

Next, the CPU 51 proceeds to Step 610 and calculates the largest value among the wheel speeds Vw** as the estimated vehicle body speed Vso. Notably, the average of the wheel speeds Vw** may be calculated as the estimated vehicle body speed Vso. Subsequently, the CPU 51 proceeds to Step 615 and calculates the actual slip rate Sa** of the wheel** on the basis of the value of the estimated vehicle body speed Vso calculated in Step 610, the value of the wheel speed Vw** calculated in Step 605, and the equation shown in Step 615.

Subsequently, the CPU 51 proceeds to Step 620 and calculates the wheel acceleration DVw** of the wheel**, which is a time-differentiated value of the wheel speed Vw**, in accordance with the following Eq. 1. In Step 625 subsequent to Step 620, the CPU 51 calculates the estimated vehicle body acceleration DVso, which is a time-differentiated value of the estimated vehicle body speed Vso calculated in Step S610, in accordance with the following Eq. 2. Subsequently, the CPU 51 proceeds to Step 695 so as to end the present routine. After that, the CPU 51 repeatedly executes the present routine.
DVw**=(Vw**−Vwl**)/Δt Eq. 1
DVso=(Vso−Vsol)/Δt Eq. 2

In Eq. 1, Vwl** represents the wheel speed Vw** calculated in Step 605 during the previous execution of the present routine, and Δt represents the length of the above-described, predetermined intervals (the computation cycles of the CPU 51). In Eq. 2, Vsol represents the estimated vehicle body speed Vso calculated in Step 610 during the previous execution of the present routine.

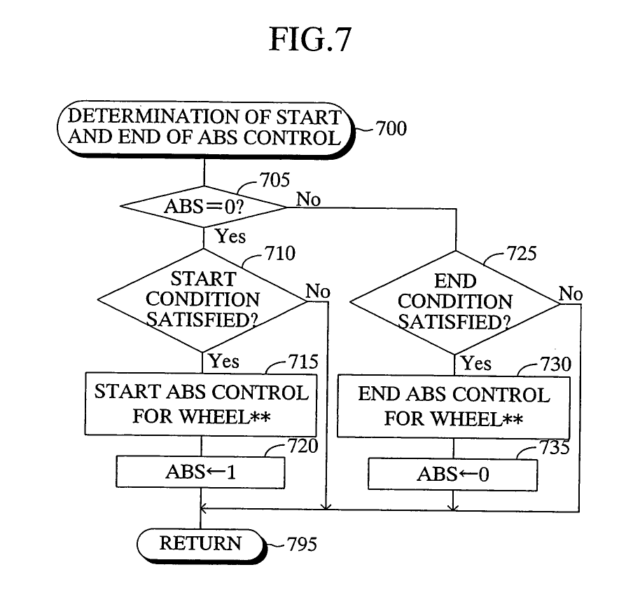

Next, operation for determining start and end of ABS control will be described. The CPU 51 repeatedly performs a routine shown in FIG. 7 at predetermined time intervals. Accordingly, when a predetermined timing is reached, the CPU 51 starts processing of the routine from Step 700, and proceeds to Step 705 so as to determine whether the value of an ABS control execution flag ABS is “0.” When the value is “1,” the ABS control execution flag ABS indicates that the above-described ABS control is currently performed. When the value is “0,” the ABS control execution flag ABS indicates that the above-described ABS control is currently halted.

The description will be continued on the assumption that the ABS control is currently halted, and ABS control start condition, which will be described later, has not been satisfied. In this case, since the value of the ABS control execution flag ABS has been set to “0,” the CPU 51 makes a “Yes” determination in Step 705, and then proceeds to Step 710 in order to determine whether the ABS control start condition is satisfied. The ABS control start condition is satisfied when, for example, the absolute value of the latest wheel acceleration DVw of a specific wheel (at least one wheel) calculated in the previous Step 620 (wheel deceleration |DVw|) is greater than a predetermined deceleration reference value DVwref (positive value), and the latest actual slip rate Sa of the specific wheel calculated in the previous Step 615 is greater than a predetermined slip rate reference value Sref (positive value).

At the present stage, the ABS control start condition is not satisfied as described above. Therefore, the CPU 51 makes a “No” determination in Step 710, and immediately proceeds to Step 795 in order to end the present routine. After that, until the ABS control start condition is satisfied, the CPU 51 repeatedly executes the processing in Steps 700 to 710 and Step 795 at the predetermined intervals.

Next, the description will be continued on the assumption that the ABS control start condition is satisfied in this state. In this case, the CPU 51 makes a “Yes” determination when it proceeds to Step 710, and then proceeds to Step 715 in order to start ABS control for a wheel** corresponding to the specific wheel. In Step 720 subsequent to Step 715, the CPU 51 sets the value of the ABS control execution flag ABS to “1.” After that, the CPU 51 proceeds to Step 795 so as to end the present routine.

Since the ABS control execution flag ABS has been set to “1” as a result of the processing in Step 720, the CPU 51 makes a “No” determination when it proceeds to Step 705, and then proceeds to Step 725 in order to determine whether a predetermined ABS control end condition is satisfied. Since the present stage is immediately after the ABS control has been started, the ABS control end condition is not satisfied. Therefore, the CPU 51 makes a “No” determination in Step 725, and immediately proceeds to Step 795 in order to end the present routine.

After that, until the ABS control end condition is satisfied, the CPU 51 repeatedly executes the processing in Steps 700, 705, 725, and 795 at the predetermined intervals. In other words, the value of the ABS control execution flag ABS is maintained at “1” during execution of the ABS control.

Next, the description will be continued on the assumption that the ABS control end condition is satisfied in this state. In this case, the CPU 51 makes a “Yes” determination when it proceeds to Step 725, and then proceeds to Step 730 in order to stop the ABS control performed for all the wheels**. In Step 735 subsequent to Step 730, the CPU 51 sets the value of the ABS control execution flag ABS to “0.” After that, the CPU 51 proceeds to Step 795 so as to end the present routine.

Since the ABS control execution flag ABS has been set to “0” as a result of the processing in Step 735, the CPU 51 makes a “Yes” determination when it proceeds to Step 705, and then proceeds to Step 710 in order to again perform monitoring for determining whether the ABS control start condition is satisfied. Until the ABS control start condition is again satisfied, the CPU 51 repeatedly executes the processing in Steps 700 to 710 and 795. In other words, the value of the ABS control execution flag ABS is maintained at “0” while the ABS control is stopped.

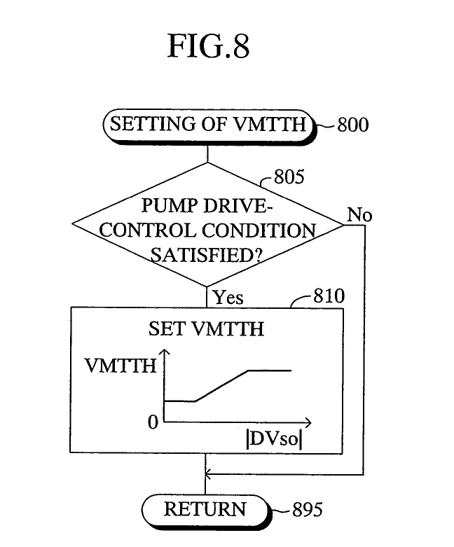

Next, operation for setting the above-described voltage threshold VMTTH will be described. The CPU 51 repeatedly performs a routine shown in FIG. 8 at predetermined time intervals. Accordingly, when a predetermined timing is reached, the CPU 51 starts processing of the routine from Step 800, and proceeds to Step 805 so as to determine whether the above-described pump drive-control condition is satisfied. When the CPU 51 makes a “No” determination, the CPU 51 immediately proceeds to Step 895 so as to end the present routine.

The pump drive-control condition is satisfied, for example, over a period between a point in time at which the ABS control is started and a point in time at which a predetermined period of time has elapsed after the end of the ABS control. In other words, the pump drive-control condition is satisfied over a period between a point in time at which the value of the ABS control execution flag ABS changes from “0” to “1” and a point in time at which the predetermined period of time has elapsed after the value of the ABS control execution flag ABS changes from “1” to “0.” Here, the description will be continued on the assumption that the pump drive-control condition is satisfied (see, for example, a period after t1 in FIG. 5). In this case, the CPU 51 makes a “Yes” determination in Step 805, and then proceeds to Step 810 in order to set the voltage threshold VMTTH on the basis of an estimated vehicle body deceleration |DVso|, which is the absolute value of the latest estimated vehicle body acceleration DVso calculated in Step 625 of FIG. 6, and with reference to a map similar to that shown in FIG. 4. Subsequently, the CPU 51 proceeds to Step 895 so as to end the present routine.

After that, so long as the pump drive-control condition is satisfied, the CPU 51 updates the voltage threshold VMTTH at the predetermined intervals by repeatedly executing the processing in Step 810 at the predetermined intervals.

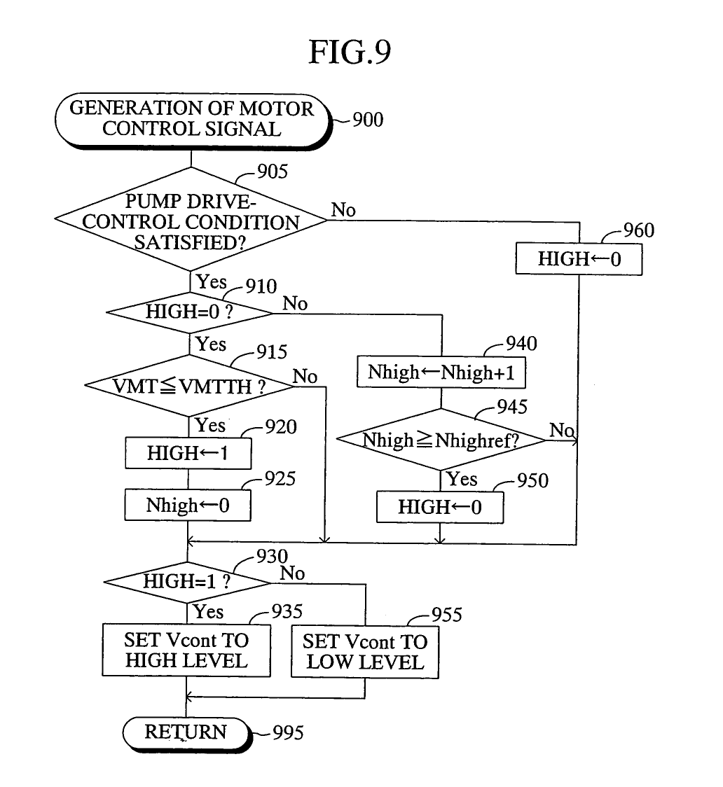

Next, operation for generating the motor control signal Vcont will be described. The CPU 51 repeatedly performs a routine shown in FIG. 9 at predetermined time intervals. Accordingly, when a predetermined timing is reached, the CPU 51 starts processing of the routine from Step 900, and proceeds to Step 905 so as to determine whether a pump drive-control condition similar to that in Step 805 is satisfied.

Here, the description will be continued on the assumption that the pump drive-control condition is satisfied, the motor control signal Vcont is at the Low level, and the motor inter-terminal voltage VMT (see FIG. 3) is not greater than the latest voltage threshold VMTTH, which is repeatedly updated through the processing in Step 810 of FIG. 8 (see, for example, time t1 in FIG. 5). The CPU 51 makes a “Yes” determination in Step 905, and proceeds to Step 910 so as to determine whether the value of a high level flag HIGH is “0.” When the value is “1,” the high level flag HIGH indicates that the motor control signal Vcont is set to the High level. When the value is “0,” the high level flag HIGH indicates that the motor control signal Vcont is set to the Low level.

At the present stage, the motor control signal Vcont is at the Low level. Therefore, the CPU 51 makes a “Yes” determination in Step 910, and proceeds to Step 915 so as to determine whether the motor inter-terminal voltage VMT is equal to or smaller than the latest voltage threshold VMTTH. Since the motor inter-terminal voltage VMT is smaller than the latest voltage threshold VMTTH, the CPU 51 makes a “Yes” determination in Step 915, and proceeds to Step 920. The CPU 51 sets the value of the high level flag HIGH to “1” in Step 920, and clears or sets a counter value Nhigh to “0” in Step 925 subsequent to Step 920. The counter value Nhigh represents a time elapsed after the value of the high level flag HIGH has changed from “0” to “1” (i.e., after the motor control signal Vcont has changed from the Low level to the High level).

Subsequently, the CPU 51 proceeds to Step 930 so as to determine whether the value of the high level flag HIGH is “1.” At the present stage, the value of the high level flag HIGH has been set to “1” by means of the processing in the previous Step 920. Accordingly, the CPU 51 makes a “Yes” determination in Step 930, and proceeds to Step 935 so as to set the motor control signal Vcont to the High level and supply it to the base terminal of the power transistor Tr (see FIG. 3). Thus, the drive of the motor MT (accordingly, the hydraulic pumps HPf and HPr) is started.

After that, the value of the high level flag HIGH is maintained at “1.” Therefore, so long as the pump drive-control condition is satisfied, the CPU 51 makes a “Yes” determination in Step 905 and then a “No” determination in Step 910, and then proceeds to Step 940, in which the CPU 51 increments the counter value Nhigh (“0” at the present stage) by “1.”

Subsequently, the CPU 51 proceeds to Step 945 in order to determine whether the counter value Nhigh has become equal to or greater than a predetermined high level maintaining reference value Nhighref corresponding to the predetermined period of time Thigh (accordingly, whether the predetermined period of time Thigh has elapsed after the point in time at which the motor control signal Vcont changes from the Low level to the High level).

Since the present stage is immediately after the motor control signal Vcont has changed from the Low level to the High level, the CPU 51 makes a “No” determination in Step 945, and immediately proceeds to Step 930. Since the value of the high level flag HIGH is maintained at “1,” the CPU 51 makes a “Yes” determination in Step 930, and again performs the processing in Step 935. After that, until the counter value Nhigh reaches the predetermined high level maintaining reference value Nhighref upon repeated execution of the processing in Step 940 (accordingly, until the predetermined period of time Thigh elapses), the CPU 51 repeatedly executes the processing in Steps 900 to 910, 940, 945, 930, and 935 at the predetermined intervals. Thus, the supply of the motor control signal Vcont of the High level to the power transistor Tr is continued (see, for example, a period between t1 to t2 in FIG. 5), so that the drive of the motor MT (accordingly, the hydraulic pumps HPf and HPr) is continued.

Here, the predetermined period of time Thigh is assumed to have elapsed in this state (see, for example, time t2 in FIG. 5). In this case, the CPU 51 makes a “Yes” determination when it proceeds to Step 945, and proceeds to Step 950. After setting the value of the high level flag HIGH to “0” in Step 950, the CPU 51 proceeds to Step 930.

As a result, the CPU 51 makes a “No” determination in Step 930, and proceeds to Step 955 so as to set the motor control signal Vcont to the Low level and supply it to the base terminal of the power transistor Tr. Thus, the drive of the motor MT (and accordingly the drive of the hydraulic pumps HPf and HPr) is stopped. After that, since the value of the high level flag HIGH is maintained at “0,” so long as the pump drive-control condition is satisfied, the CPU 51 makes a “Yes” determination in Steps 905 and 910, and then proceeds to Step 915 in order to again perform monitoring for determining whether the motor inter-terminal voltage VMT becomes equal to or less than the latest voltage threshold VMTTH.

When the rotational speed of the motor MT decreases with elapse of time and the motor inter-terminal voltage VMT becomes equal to or less than the latest voltage threshold VMTTH (see, for example, time t3 in FIG. 5), the CPU 51 again makes a “Yes” determination at Step 915, and executes the processing in Steps 920 to 935 in order to again supply the motor control signal Vcont of the High level to the base terminal of the power transistor Tr. As a result, the drive of the motor MT (and accordingly, drive of the hydraulic pumps HPf and HPr) is started.

The CPU 51 repeatedly performs the above-described processing at the predetermined intervals. When satisfying the pump drive-control condition becomes impossible (for example, when the predetermined period of time elapses after the ABS control is ended), the CPU 51 makes a “No” determination when it proceeds to Step 905, and then proceeds to Step 960. The CPU 51 sets the value of the high level flag HIGH to “0” in Step 960, and performs the processing in Steps 930 and 955 to thereby supply the motor control signal Vcont of the Low level to the base terminal of the power transistor Tr.

After that, until the pump drive-control conditions is again satisfied (e.g., until the ABS control is again started), the CPU 51 repeatedly executes the processing in Steps 900, 905, 960, 930, and 955. As a result, the motor control signal Vcont is maintained at the Low level, and the drive of the motor MT (and accordingly, the drive of the hydraulic pumps HPf and HPr) is stopped continuously.

As described above, in the pump drive motor control apparatus of the present invention, as the deceleration of the vehicle body during ABS control (that is, the estimated vehicle body deceleration |DVso|), which can serve as a value representing the friction coefficient of a road surface on which the vehicle travels, decreases (i.e., as the friction coefficient of the road surface decreases), the voltage threshold VMTTH, which affects the rotational speed (its time-average) of the motor MT, decreases, so that the rotational speed (its time-average) of the motor MT decreases. Accordingly, reduction of the operation sound of the motor MT (and the hydraulic pumps HPf and HPr) and avoidance of failure of the ABS control can be realized simultaneously.

The present invention is not limited to the above-described embodiment, and various modifications may be practiced without departing from the scope of the present invention. For example, the pump drive motor control apparatus of the above-described embodiment is configured in such a manner that when the voltage generated by the motor MT (the motor inter-terminal voltage VMT) becomes equal to or less than the predetermined threshold (the voltage threshold VMTTH), supply of electricity to the motor MT is resumed (the motor control signal Vcont is switched from the Low level to the High level), and after passage of the predetermined period of time Thigh (constant time) after that, the supply of electricity to the motor MT is stopped (the motor control signal Vcont is switched from the High level to the Low level). However, the pump drive motor control apparatus may be modified in such a manner that a predetermined period of one cycle for the on-off control is set, and the supply of electricity to the motor MT is resumed when the voltage generated by the motor MT becomes equal to or less than the predetermined threshold and is stopped after every passage of the predetermined period of one cycle.

In the above-described embodiment, the estimated vehicle body deceleration |DVso| is used as a deceleration of the vehicle body during ABS control, which can serve as a value representing the friction coefficient of a road surface. However, an acceleration sensor capable of detecting acceleration in the front-back direction of the vehicle body may be provided, the deceleration of the vehicle body being obtained on the basis of the output of the acceleration sensor.

In the above-described embodiment, with attention paid to the fact that the flow rate of brake fluid returned to the reservoirs decreases with the friction coefficient of a road surface, the estimated vehicle body deceleration |DVso| during ABS control is employed as a “value which varies in accordance with road surface conditions,” and the voltage threshold VMTTH is lowered with the estimated vehicle body deceleration |DVso|. However, with attention paid to the fact that the flow rate of brake fluid returned to the reservoirs increases when the vehicle travels on a poor road (road in poor condition), the pump drive motor control apparatus of the embodiment may be modified in such a manner that a value representing a variation among the wheel speeds Vw** (a value representing the degree of roughness of a road surface) is employed as a “value which varies in accordance with road surface conditions;” poor road determination means is provided for determining, on the basis of the value representing the variation among the wheel speeds Vw**, whether the vehicle travels on a poor road (e.g., a wavy road or the like); and when the vehicle is determined to travel on a poor road, the voltage threshold VMTTH is set to a predetermined high value (e.g., a value higher than the maximum value (Vthh (V)) of the voltage threshold VMTTH shown in FIG. 4).

1. A pump drive motor control apparatus for controlling a motor for driving a pump, comprising:
control means for controlling rotational speed of the motor through on-off control performed such that supply of electricity to the motor is resumed on the basis of a result of comparison between a threshold and a voltage which the motor generates in a state in which supply of electricity to the motor is stopped; and
threshold changing means for changing the threshold in accordance with a quantity of working fluid which the pump is required to discharge.

2. A pump drive motor control apparatus according to claim 1, wherein
the control means is configured to resume supply of electricity to the motor when the voltage which the motor generates in a state in which supply of electricity to the motor is stopped becomes equal to or less than the threshold.

3. A pump drive motor control apparatus according to claim 1, wherein
the pump driven by the motor is a hydraulic pump used in a brake fluid pressure controller of a vehicle including at least an antilock brake system, the hydraulic pump pumping brake fluid returned to a reservoir as a result of operation of the brake fluid pressure controller and supplying the pumped brake fluid to a hydraulic circuit of the brake fluid pressure controller;
the control means controls the rotational speed of the motor at least during a period in which the brake fluid pressure controller is operating; and
the threshold changing means changes the threshold on the basis of a value varying in accordance with conditions of a road surface on which the vehicle travels, during the period in which the brake fluid pressure controller is operating.

4. A pump drive motor control apparatus according to claim 2, wherein
the pump driven by the motor is a hydraulic pump used in a brake fluid pressure controller of a vehicle including at least an antilock brake system, the hydraulic pump pumping brake fluid returned to a reservoir as a result of operation of the brake fluid pressure controller and supplying the pumped brake fluid to a hydraulic circuit of the brake fluid pressure controller;
the control means controls the rotational speed of the motor at least during a period in which the brake fluid pressure controller is operating; and
the threshold changing means changes the threshold on the basis of a value varying in accordance with conditions of a road surface on which the vehicle travels, during the period in which the brake fluid pressure controller is operating.

5. A pump drive motor control apparatus according to claim 3, wherein the threshold changing means is configured to change the threshold on the basis of deceleration of the vehicle body during a period in which the brake fluid pressure controller is operating, the deceleration serving as the value varying in accordance with road surface conditions.

6. A pump drive motor control apparatus according to claim 3, wherein the threshold changing means is configured to change the threshold on the basis of a value representing the degree of roughness of road surface during a period in which the brake fluid pressure controller is operating, the value representing the degree of roughness serving as the value varying in accordance with road surface conditions.

7. A pump drive motor control apparatus according to claim 6, wherein the value representing the degree of roughness of road surface is obtained on the basis of a value representing the degree of variation among the wheel speeds of the wheels.

8. A pump drive motor control apparatus according to claim 4, wherein the threshold changing means is configured to change the threshold on the basis of deceleration of the vehicle body during a period in which the brake fluid pressure controller is operating, the deceleration serving as the value varying in accordance with road surface conditions.

9. A pump drive motor control apparatus according to claim 4, wherein the threshold changing means is configured to change the threshold on the basis of a value representing the degree of roughness of road surface during a period in which the brake fluid pressure controller is operating, the value representing the degree of roughness serving as the value varying in accordance with road surface conditions.

10. A pump drive motor control apparatus according to claim 9, wherein the value representing the degree of roughness of road surface is obtained on the basis of a value representing the degree of variation among the wheel speeds of the wheels.
